(19) United States
(12) Patent Application Publication
(10) Pub. No.: US 2011/0044199 A1
(43) Pub. Date: Feb. 24, 2011

(54) Method for Determining the Round Trip Time

(76) Inventors: Muhammad Kazmi, Bromma (SE); Martin Israelsson, Spanga (SE); Dirk Gerstenberger, Stockholm (SE); Torbjörn Wigren, Uppsala (SE); Robert Baldemair, Solna (SE)

Correspondence Address: ERICSSON INC., 6300 LEGACY DRIVE, M/S EVR 1-C-11, PLANO, TX, 75024, US

(21) Appl. No.: 12/989,446

(22) PCT Filed: Jun. 24, 2008
(86) PCT No.: PCT/SE08/50755

§ 371 Date: Oct. 25, 2010

Related U.S. Application Data
(60) Provisional application No. 61/047,815, filed on Apr. 25, 2008.

(51) Int. Cl. H04L 12/26

(52) U.S. Cl. 370/252

(57) ABSTRACT

A method in a first node for determining a round trip time of a signal sent between the first node and a second node includes sending a first signal to the second node and receiving a second signal, corresponding to the sent first signal. The second signal is sent from the second node as a response to the sent first signal. The method also includes computing the round trip time of the signal and sending the computed round trip time to the second node.

### TECHNICAL FIELD

The present invention relates to a method and an arrangement in a first node and to a method and an arrangement in a second node. More particularly the present invention relates to a mechanism for providing and obtaining, respectively, the round trip time of radio signals travelling between two nodes of a communication system.

### BACKGROUND

Currently, standardized and commercially deployed radio access technologies are proliferated. Such radio access technologies include the Global System for Mobile communications (GSM), Enhanced Data Rates for GSM Evolution (EDGE), General Packet Radio System (GPRS), Wide-band Code Division Multiple Access (WCDMA), Long Term Evolution (LTE) systems, Wireless Local Area Networks (WLAN), CDMA 2000 and others.

Positioning in wireless communication systems comprising these or other technologies can be performed in many different ways. A typical approach is that a request for positioning is provided. If the positioning information is not already available, some kind of measurement may be performed, and positioning data may be reported to a node responsible for the actual positioning.

Fingerprinting positioning algorithms operate by creating a radio fingerprint for each point of a fine coordinate grid that covers the Radio Access Network. The fingerprint may e.g. comprise the cell IDs that are detected by the terminal, in each grid point, or quantized path loss or signal strength measurements, with respect to multiple radio base stations, performed by the terminal, in each grid point.

Whenever a position request arrives, a radio fingerprint is firstly computed, based on various parameters which needs to be measured. Thereafter the corresponding grid point is looked up and reported. This requires that the point is unique. A major problem with this approach is that extensive surveying needs to be performed when the fingerprinting database is created. Extra parameter measurements and extra signalling in general has to be performed.

It is thus a problem with existing positioning methods, to generate radio fingerprints that are unique without spending too much radio resources on measurements and signalling. Additional parameter measurements and extra signalling in general have an influence on the overall system load and thus decrease the capacity.

It is thus a problem with existing positioning methods to generate radio fingerprints that are unique without spending too much radio resources on surveying.

### SUMMARY

It is therefore an object of the present invention to provide an improved measurement mechanism for a communication system.

According to a first aspect, the object is achieved by a method in a first node for determining the round trip time of a signal. The signal is sent between the first node and a second node. The second node is associated with a location point. The first node and the second node are comprised within a wireless communication system. Also, the first node and the second node are adapted to exchange wireless signals. A first signal is sent to the second node. A second signal is thereafter received from the second node, which second signal is sent from the second node as a response to the previously sent first signal. When the second signal is received from the second node, the round trip time of the signal is computed. The computed round trip time is then sent to the second node.

According to a second aspect, the object is also achieved by an arrangement in a first node for determining the round trip time of a signal. The signal is sent between the first node and a second node. The second node is associated with a location point. The first node and the second node are comprised within a wireless communication system. The first node and the second node are further adapted to exchange wireless signals. The arrangement comprises a first sending unit, a receiving unit, a computing unit and a second sending unit. The first sending unit is adapted to send a signal, the receiving unit is adapted to receive a signal and the computing unit is adapted to compute the round trip time of a signal. The second sending unit is adapted to send the computed round trip time to the second node.

According to a third aspect, the object is achieved by a method in a second node for obtaining the round trip time of a signal sent between a first node and the second node. The second node is associated with a location point. The first node and the second node are comprised within a wireless communication system. Also, the first node and the second node are adapted to exchange wireless signals. A first signal is received from the first node. Thereafter, a second signal corresponding to the received first signal is sent to the first node. The second signal is sent as a response to the received first signal. Then the round trip time of the signal is obtained from the second node.

According to a fourth aspect, the object is also achieved by an arrangement in a second node for obtaining the round trip time of a signal. The second node is associated with a location point. The signal is sent between a first node and the second node. The first node and the second node are comprised within a wireless communication system. Further, the first node and the second node are adapted to exchange wireless signals. The second node arrangement comprises a receiving unit, a sending unit and an obtaining unit. The receiving unit is adapted to receive a first signal from the first node. The sending unit is adapted to send a second signal, corresponding to the received first signal. The signal is sent to the first node, as a response to the received first signal. The obtaining unit is adapted to obtain the round trip time of the signal from the second node.

Thanks to the measurement of the round trip time according to the present methods, measured with respect to the location point of the user equipment, and the sending of the made measurement according to any of the present solutions, an appropriate and unique radio fingerprint may be generated and provided with reduced overhead signalling involved. Thereby an improved measurement mechanism in a wireless communication system is provided.

An advantage with the present methods and arrangements is that they enable user equipment based fingerprinting positioning for determining the position of a user equipment with better accuracy.

A further advantage with the present signalling methods is that they allow the reporting of round trip time to the user equipment, with reduced signalling overhead.

Yet an advantage with the present methods is that they enable network based fingerprinting positioning for determining the position of the user equipment with better accuracy.

### BRIEF DESCRIPTION OF THE DRAWINGS

The present invention will now be described more in detail in relation to the enclosed drawings, in which:

FIG. 1 is a schematic block diagram illustrating a wireless communication system according to some embodiments.

FIG. 2 is a schematic block diagram illustrating a wireless communication system according to some embodiments.

FIG. 3 is a schematic block diagram illustrating exemplary components of a first node according to some embodiments.

FIG. 4A is a schematic block diagram illustrating exemplary components of a second node according to some embodiments.

FIG. 4B is a schematic block diagram illustrating a second node according to some embodiments where the second node is embodied as a cellular telephone.

FIG. 5 is a combined signalling and flowchart illustrating radio signal transmission according to some embodiments.

FIG. 6 is a schematic flow chart illustrating an embodiment of the present method in a first node.

FIG. 7 is a schematic block diagram illustrating an arrangement in a first node according to some embodiments.

FIG. 8 is a schematic flow chart illustrating an embodiment of the present method in a second node.

FIG. 9 is a schematic block diagram illustrating an arrangement in a second node according to some embodiments.

### DETAILED DESCRIPTION

The invention is defined as a method and arrangement in a first node and as a method and arrangement in a second node, which may be put into practice in the embodiments described below. This invention may, however, be embodied in many different forms and should not be considered as limited to the embodiments set forth herein; rather, these embodiments are provided so that this disclosure will be thorough and complete, and will fully convey the scope of the invention to those skilled in the art.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

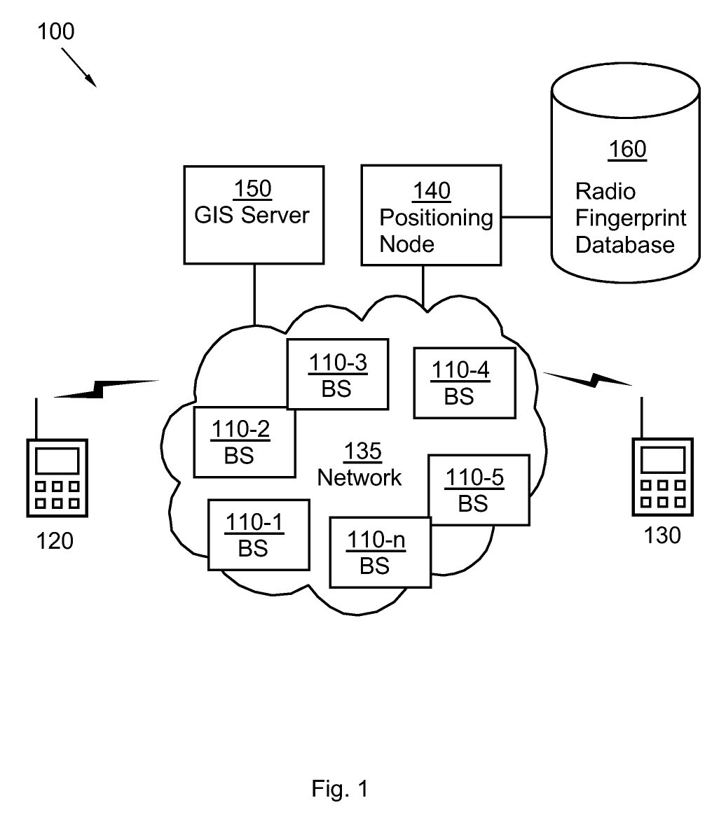

FIG. 1 is a schematic block diagram illustrating an exemplary wireless communication system 100, according to some embodiments. The wireless communication system 100 comprises one or multiple first nodes 110, one or multiple second nodes 120, 130 and a network 135. The wireless communication system 100 may optionally also comprise a positioning node 140 and a Geographic Information System (GIS) server 150 connected to the network 135.

It will be appreciated that the number of components illustrated in FIG. 1 is purely exemplary. Other configurations with more, fewer, or a different arrangement of components may be implemented. Moreover, in some embodiments, one or more components in FIG. 1 may perform one or more of the tasks described as being performed by one or more other components in FIG. 1.

The first node 110 may also be referred to as e.g. a base station, an access point, a Node B, an evolved Node B (eNode B) and/or a base transceiver station, Access Point Base Station, base station router, etc depending e.g. of the radio access technology and terminology used. In FIG. 1, the first node 110 is represented by the base stations 110-1, 110-2, 110-3, 110-4, 110-5, . . . , 110-n.

According to some embodiments however, the first node 110 may be represented by a user equipment, such as e.g. a wireless communication terminal, a mobile cellular telephone, a Personal Communications Systems terminal, a Personal Digital Assistant (PDA), a laptop, a computer or any other kind of device capable of managing radio resources.

The second node 120, 130 may be represented by e.g. a user equipment, a wireless communication terminal, a mobile cellular telephone, a Personal Communications Systems terminal, a Personal Digital Assistant (PDA), a laptop, a computer or any other kind of device capable of managing radio resources may communicate wirelessly with the base station 110 within the network 135. A Personal Communication System terminal may combine a cellular radiotelephone with data processing, facsimile and data communications capabilities. A PDA may include a radiotelephone, a pager, an Internet/intranet access device, a web browser, an organizer, calendars and/or a global positioning system (GPS) receiver. One or more of the second node 120, 130 may be referred to as a “pervasive computing” device. In some implementations, the second node 120, 130 may be represented by a telephone that is connected to a Public Switched Telephone Network.

According to some embodiments however, the second node 120, 130 may be represented by a base station, such as e.g. an access point, a Node B, an evolved Node B (eNode B) and/or a base transceiver station, Access Point Base Station, base station router, etc depending e.g. of the radio access technology and terminology used.

A first instance of the second node 120 may communicate with another, second instance of the second node 130, or with other nodes not shown, via the network 135 in the wireless communication system 100.

In one implementation, one second node 120 may communicate with another second node 130 via one or more other network nodes that act as intermediate devices between the first instance of the second node 120 and the second instance of the second node 130. For example, as shown in FIG. 1, the first node 110-1, which may include wireless base station functionality, may reside as an intermediate component of the network 135 that may be used to facilitate end-to-end communication between the second nodes 120 and 130 or between the second nodes 120, 130 and e.g. the positioning node 140 or GIS server 150. Additional instances of the first node 110-2 through 110-n may be comprised within the network 135.

The first node 110-1 through 110-n may interface with the respective second nodes 120, 130, such that e.g., first node 110-1 may interface with the second node 120, via respective wireless links and may perform, among other functions, Medium Access Control (MAC) and Radio Link Control (RLC).

The positioning node 140 may determine the location of second node 120, 130 in the wireless communication system 100. The optional positioning node 140 may be associated with a radio fingerprint database 160 that stores radio fingerprints derived e.g. from Evolved Universal Terrestrial Radio Access Network (E-UTRAN) and/or inter-Radio Access Technology (IRAT) measurement data. The database 160 may reside internal or external to positioning node 140 and may according to some embodiments be remotely connected to. The E-UTRAN and/or IRAT measurement data may be provided to the positioning node 140, in conjunction with precise geographic position data obtained at the same geographic location at which the E-UTRAN and/or IRAT measurements were performed, e.g., GPS geographic position data. Also, the positioning node 140 may organize the precise geographic position data into clusters having a same or similar radio fingerprint. The positioning node 140 may further determine the cluster boundaries of each cluster and store the cluster boundary information, associated radio fingerprints, and precise geographic position data in the radio fingerprint database 160. The positioning node 140 may subsequently receive E-UTRAN and/or IRAT radio fingerprint measurement data from the first instance of the second node 120 and/or from the second instance of the second node 130 and may perform a lookup into the radio fingerprint database 160 to identify a radio fingerprint stored in the database 160 that matches the received E-UTRAN and/or IRAT radio fingerprint measurement data, and to retrieve a precise geographic position stored in the database 160 that corresponds to the matching radio fingerprint. The positioning node 140 may provide this geographic position to the second node 120, 130 that sent the radio fingerprint measurement data, or to other destinations, such as, for example, an emergency or police call centre.

The GIS server 150 may comprise one or more server entities that provide geographic mapping services, or related mapping services. The GIS server 150 may receive geographic position data concerning the user equipment 120, 130 from the positioning node 140, or from the user equipment 120, 130, and may map the received geographic position data to physical coordinates or a physical address, or perform other mapping related services with the geographic position data.

The network 135 may comprise one or more networks of any type, including a Local Area Network (LAN); a Wide Area Network (WAN); a Metropolitan Area Network (MAN); a telephone network, such as a Public Switched Telephone Network (PSTN) or a Public Land Mobile Network (PLMN); a satellite network; an intranet, the Internet; or a combination of these or other networks. The PLMN may further include a packet-switched sub-network, such as, for example, General Packet Radio Service (GPRS), Cellular Digital Packet Data (CDPD), or Mobile IP network.

The radio access technologies used for wireless communication within the wireless communication system 100 may comprise technologies such as e.g. Code division multiple access (CDMA), Wideband Code Division Multiple Access (WCDMA), CDMA 2000, High Speed Downlink Packet Data Access (HSDPA), High Data Rate (HDR) etc, just to mention a few examples.

As used herein, the wireless communication system 100 may refer to various radio access technologies without departing from the teachings of the present invention. These radio access technologies may include, for example, radio access technologies, such as Long Term Evolution (LTE), Enhanced Data rates for GSM Evolution (EDGE), General Packet Radio Service (GPRS), Global System for Mobile Telecommunications (GSM), High Speed Packet Data Access (HSPA), Universal Mobile Telecommunications System (UMTS) and/or Wireless Local Area Networks (WLAN), such as Wireless Fidelity (WiFi) and Worldwide Interoperability for Microwave Access (WiMAX), Bluetooth or according to any other wireless communication standard.

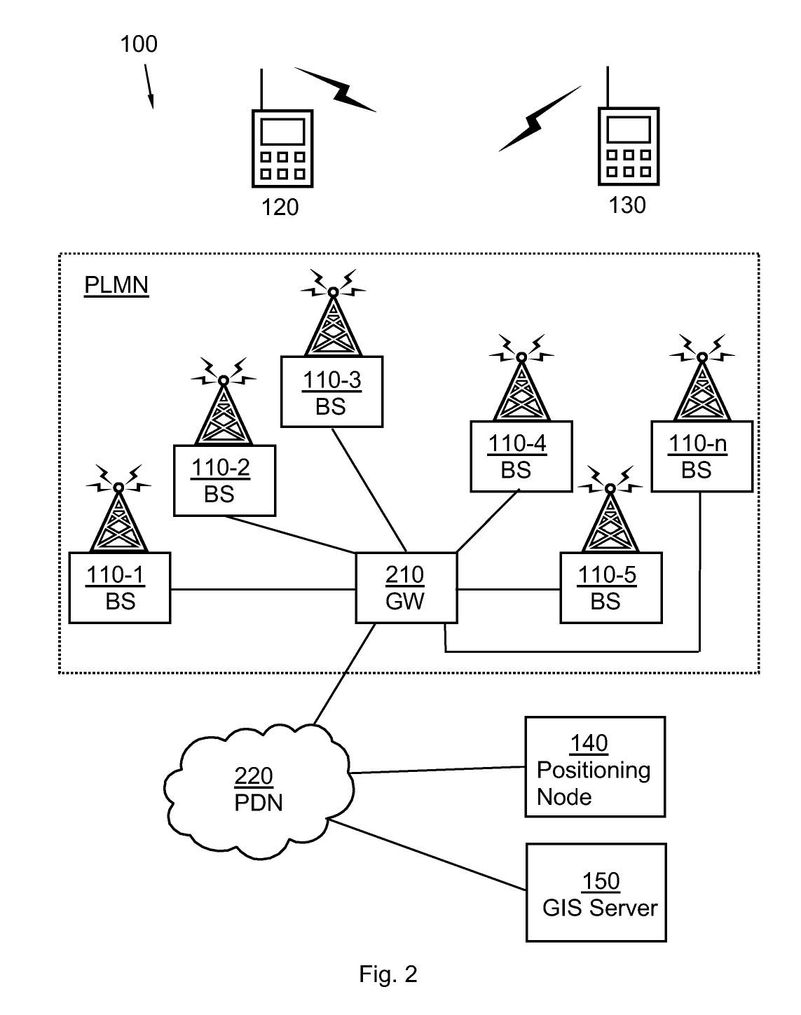

FIG. 2 illustrates an example of the wireless communication system 100 of FIG. 1, where the wireless communication system 100 comprises a PLMN. The PLMN may implement a Long Term Evolution (LTE) system architecture. As shown in FIG. 2, the second nodes 120, 130 may comprise user equipment such as e.g. cellular radiotelephones that are communicating with one another via the PLMN. The PLMN may include multiple first nodes 110, e.g. base stations 110-1 through 110-N along with their associated antenna arrays and one or more gateways (GW) 210. The gateway 210 may further connect to a Packet Data Network (PDN) 220 of the wireless communication system 100 which may further connect to the optional positioning node 140 and the optional GIS server 150. The PDN 220 may include any type of packet-switched network, such as, for example, the Internet.

The base stations 110-1 through 110-n may interface with respective user equipments 120, 130, e.g., base station 110-1 may interface with the first user equipment 120 via respective wireless links and may perform, among other functions, Medium Access Control (MAC) and Radio Link Control (RLC). For example, the first base station 110-1 may receive data transmissions from the user equipment 120 and may forward those data transmissions on to the gateway 210. The gateway 210 may route data transmissions received from a respective base station 110 to another base station 110, or to the positioning node 140 or to the GIS server 150 via PDN 220. The gateway 210 may further route data transmissions received from positioning node 140 or GIS server 150 via PDN 220 to the respective base station 110-1 through 110-n associated with the destination user equipment 120, 130. Though positioning node 140 is shown in FIG. 2 as connected to the PLMN by way of PDN 220, in other implementations, the positioning node 140 may reside as a component of PLMN, e.g. connected internally to the PLMN without messaging having to traverse PDN 220.

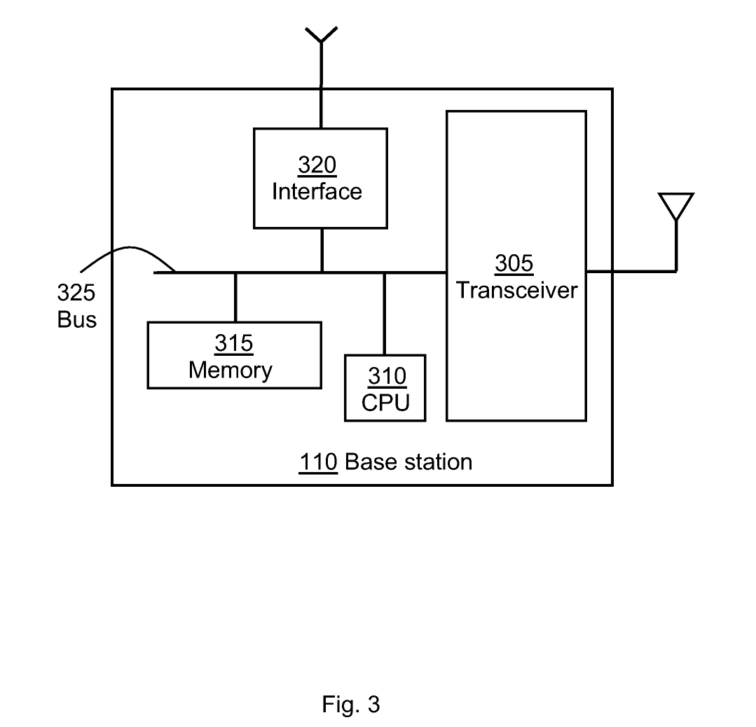

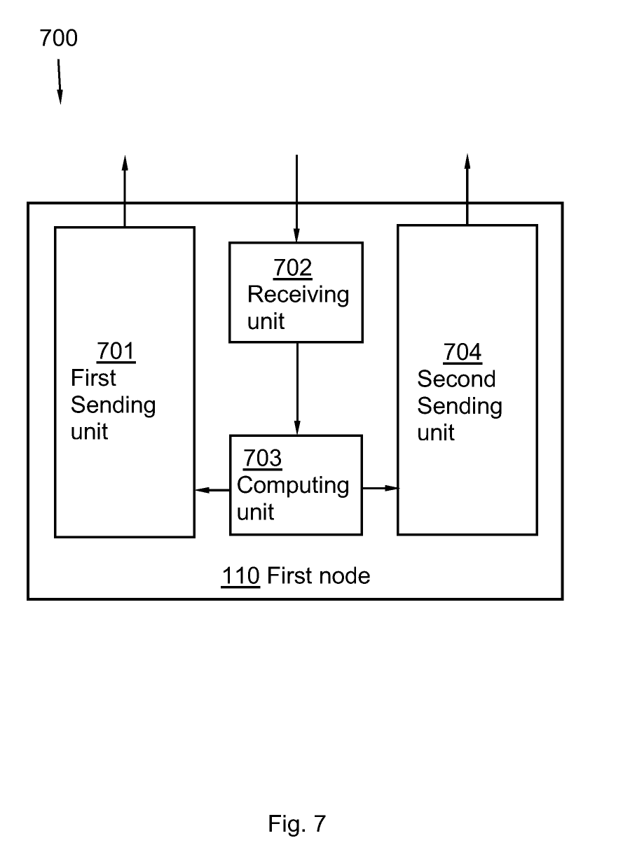

FIG. 3 illustrates one exemplary implementation of the base station 110-1. Base stations 110-2 through 110-n may be similarly configured. The optional positioning node 140 and the optional GIS server 150 may also be similarly configured, however, the positioning node 140 and the GIS server 150 may not comprise the transceiver 305, according to some embodiments. The base station 110-1 may comprise e.g. a transceiver 305, a processing unit 310, a memory 315, an interface 320 and a bus 325. Further, the base station 110 may comprise an arrangement adapted to measure and obtain a value of a round trip time of a signal sent between the base station 110 and the user equipment 120, as later will be explained in detail referring to FIG. 7.

The transceiver 305 may comprise transceiver circuitry for transmitting and/or receiving symbol sequences using radio frequency signals via one or more antennas. The one or more antennas may comprise a single antenna or an antenna array and may comprise directional and/or omni-directional antennas. The transceiver 305 may additionally comprise measurement circuitry that may perform e.g. one or more of various different Evolved Universal Terrestrial Radio Access Network (E-UTRAN) radio fingerprint measurements, such as, for example, measuring the Evolved Universal Terrestrial Radio Access (E-UTRA) Reference Signal (DL RS) transmit power at the base station 110-1.

The processing unit 310 may comprise a processor, microprocessor, or processing logic that may interpret and execute instructions. Further, the processing unit 310 may perform all data processing functions for the base station 110-1. The memory 315 may provide permanent, semi-permanent, or temporary working storage of data and instructions for use by the processing unit 310 in performing device processing functions. Also, the memory 315 may be a primary storage memory unit such as a processor register, a cache memory, a Random Access Memory (RAM) or similar. The memory unit 315 may however in some embodiments be a secondary memory unit such as a Read Only Memory (ROM), Electrically Erasable Programmable Read-Only Memory (EEPROM), programmable read-only memory (PROM) or erasable programmable read-only memory (EPROM) or a hard disk drive. The memory unit 315 may however in some embodiments be an off-line storage memory unit, a flash memory, a USB memory or a memory card. The memory unit 315 may further in some embodiments be a Network-attached storage (NAS) or in fact any other appropriate medium such as and/or optical recording medium and its corresponding drive, or any other disk, tape or media that can hold machine readable data.

The interface 320 may include circuitry for interfacing with a link that connects to gateway 210. The bus 325 may interconnect the various components of the base station 110-1 to permit the components to communicate with one another.

The configuration of components of the base station 110-1 illustrated in FIG. 3 is for illustrative purposes only. Other configurations comprising more, fewer, or a different arrangement of components may be implemented.

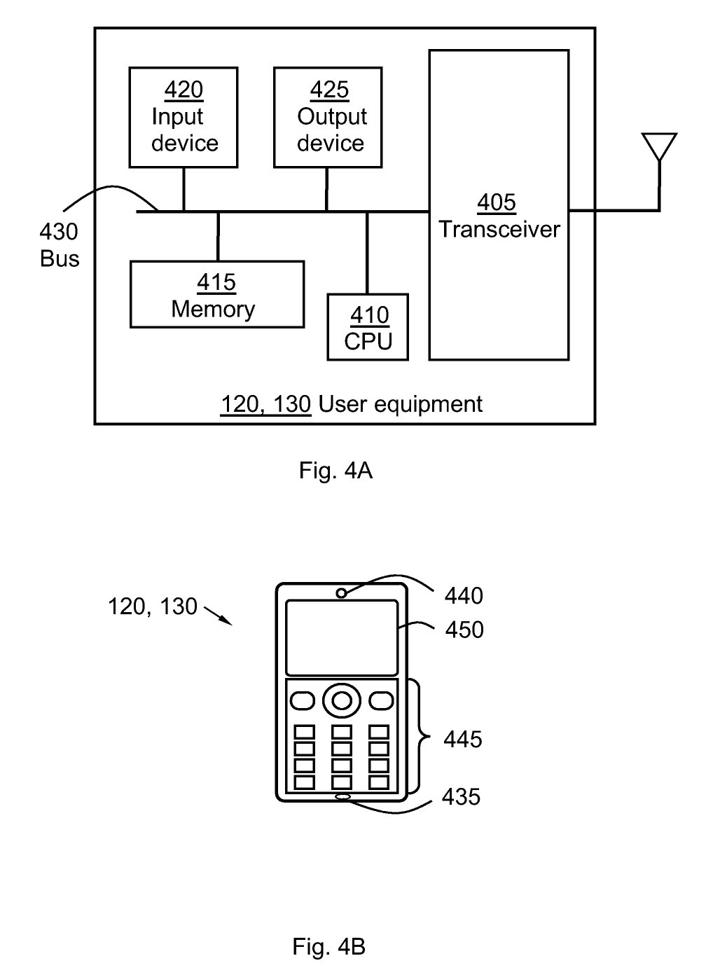

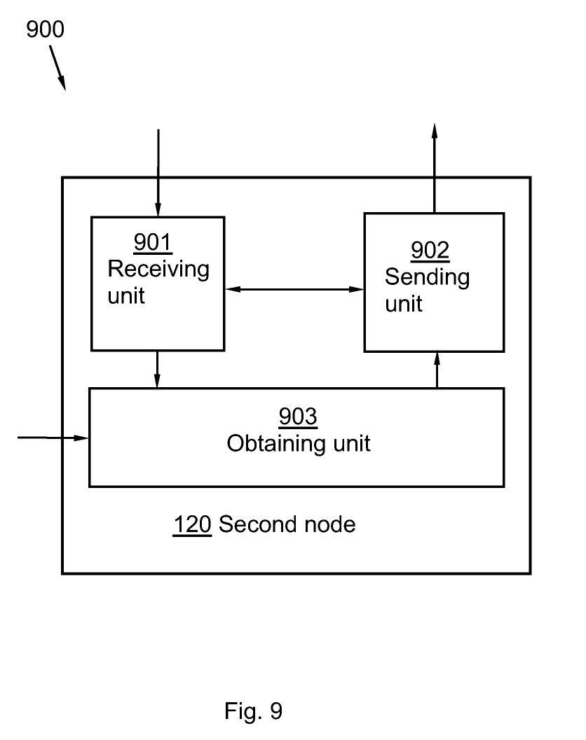

FIG. 4A illustrates the first user equipment 120 consistent with an exemplary embodiment. The second user equipment 130 may be similarly configured. The first user equipment 120 may comprise e.g. a transceiver 405, a processing unit 410, a memory 415, an input device 420, an output device 425, and a bus 430. Further, the first user equipment 120 may comprise an arrangement adapted to measure and obtain a value of a propagation delay of a signal sent to a base station 110 from the user equipment 120, as later will be explained in detail, referring to FIG. 9.

The transceiver 405 may comprise transceiver circuitry for transmitting and/or receiving symbol sequences using radio frequency signals via one or more antennas. The transceiver 405 may comprise, for example, a RAKE or a GRAKE receiver. Transceiver 405 may additionally comprise measurement circuitry that may perform one or more of various different E-UTRAN radio fingerprint measurements, based on, but not limited to, one or more of the following: a signal propagation measurement, signal propagation delay, a round trip time measurement, E-UTRA Reference Signal Received Power (RSRP); E-UTRA Carrier Received Signal Strength Indicator, (E-UTRA carrier RSSI); E-UTRA Reference Signal Received Quality (RSRQ); Wideband Code Division Multiple Access (WCDMA) UTRA Frequency Division Duplex (FDD) Common Pilot Channel (CPICH) Received Signal Code Power (RSCP); WCDMA UTRA FDD carrier RSSI; WCDMA UTRA FDD CPICH Ec/No, corresponding to a received energy per chip divided by a power density in a band; Global System for Mobile Communications (GSM) carrier RSSI; Time division duplex (TDD) mode UTRA TDD carrier RSSI; UTRA TDD Primary Common Control Physical Channel (P-CCPCH) RSCP; CDMA2000 1 times Radio Transmission Technology (1×ROUND TRIP TIME) pilot strength; and/or CDMA2000 High Rate Packet Data (HRPD) pilot strength.

The processing unit 410 may comprise a Central Processing Unit (CPU), processor, microprocessor, or processing logic that may interpret and execute instructions. The processing unit 410 may perform all data processing functions for inputting, outputting, and processing of data including data buffering and device control functions, such as call processing control, user interface control, or the like.

The memory 415 may provide permanent, semi-permanent, or temporary working storage of data and instructions for use by processing unit 410 in performing device processing functions. The memory 415 may include ROM, RAM, large-capacity storage devices, such as a magnetic and/or optical recording medium and its corresponding drive, and/or other types of memory devices. The input device 420 may comprise mechanisms for entry of data into the user equipment 120, 130. The key pad may permit manual user entry of data into the user equipment 120, 130. The microphone may comprise mechanisms for converting auditory input into electrical signals. The display unit may include a screen display that may provide a user interface, e.g., a graphical user interface that can be used by a user for selecting device functions. The screen display of the display unit may include any type of visual display, such as, for example, a Liquid Crystal Display (LCD), a plasma screen display, a Light-Emitting Diode (LED) display, a Cathode Ray Tube (CRT) display, an Organic Light-Emitting Diode (OLED) display, etc.

The output device 425 may comprise mechanisms for outputting data in audio, video and/or hard copy format. For example, the output device 425 may comprise a speaker that comprises mechanisms for converting electrical signals into auditory output. The output device 425 may further comprise a display unit that displays output data to the user. For example, the display unit may provide a graphical user interface that displays output data to the user. The bus 430 may interconnect the various components of the user equipment 120 to permit the components to communicate with one another.

The configuration of components of the user equipment 120 illustrated in FIG. 4A is for illustrative purposes only. Other configurations comprising more, fewer, or a different arrangement of components may be implemented. For example, in some implementations, the user equipment 120, 130 may comprise a GPS position measuring device, or alternatively be connected e.g. wirelessly, to an attached or associated GPS position measuring device.

FIG. 4B illustrates an exemplary implementation of the user equipment 120, 130 in which the user equipment 120, 130 comprises a cellular radiotelephone. As shown in FIG. 4B, the user equipment 120, 130 may comprise a microphone 435, e.g., of input device 420 for entering audio information into the user equipment 120, a speaker 440, e.g., of output device 425 for providing an audio output from the radiotelephone, a keypad 445, e.g., of input device 420 for manual entry of data or selection of telephone functions, and a display 450, e.g., of input device 420 or output device 425 that may visually display data to the user and/or which may provide a user interface that the user may use to enter data or to select telephone functions, in conjunction with the keypad 445.

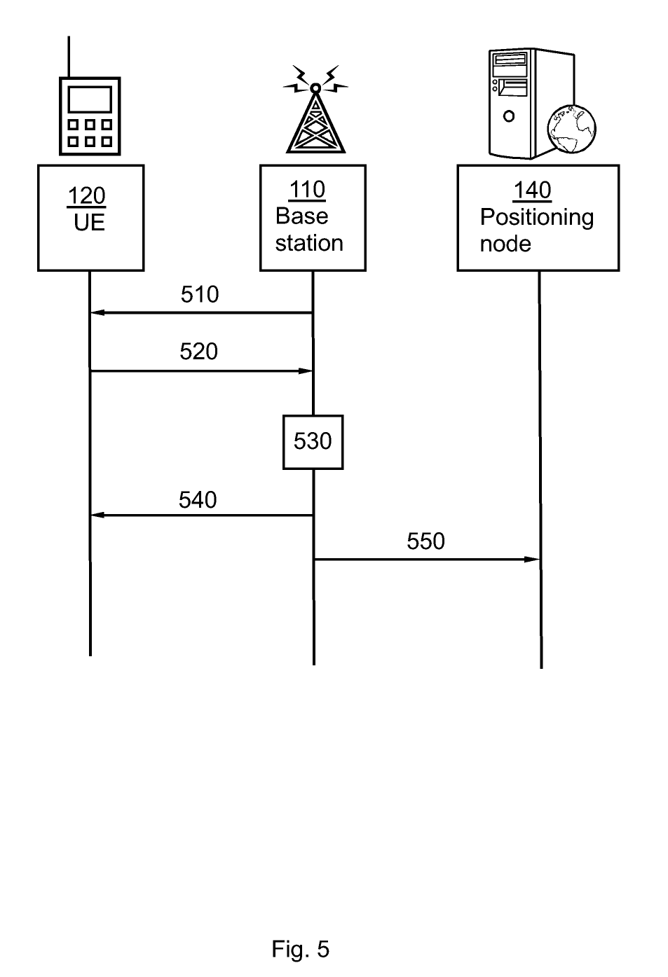

FIG. 5 is a combined signalling and flowchart that depicts the transmission of signals between a base station 110, a user equipment 120 and optionally a positioning node 140.

The base station 110 may transmit a first signal 510, to be received by the user equipment 120. The first signal 510, or rather, the corresponding response signal 520, sent from the user equipment 120 to the base station 110 may be used for estimating the round trip time.

The Round Trip Time is the time difference between the beginning of signal transmission in the downlink and the estimated 1st path of the corresponding signal received in the uplink. The round trip time may be measured at the base station 110. The Round Trip Time measurement is a user specific measurement; this means it is measured separately for each user equipment 120 in the cell.

According to some embodiments, wherein the communication system 100 is an UTRAN system, the Round Trip Time (RTT) may be specified as an UTRAN measurement. Round trip time may be defined as follows:

RTT=TRX−TTX,

Where TTX is the time of transmission of the beginning of a downlink DPCH or F-DPCH frame to the user equipment 120. TRX is the time of reception of the beginning, for the first detected path, in time of the corresponding uplink DPCCH frame from the user equipment 120.

However, according to some embodiments, wherein the communication system 100 is represented by E-UTRAN, the round trip time may also be measured at the base station 110, or “eNode B” in E-UTRAN terminology.

In E-UTRAN like in UTRAN fundamentally the round trip time may also be the time difference between the received signal 520 at the base station 110 and the transmitted signal 510 at the base station 110 that triggers the corresponding uplink transmission 520.

However the round trip time measurement as done in E-UTRAN may differ compared to UTRAN since different radio access technologies are used in UTRAN and E-UTRA. UTRAN and E-UTRAN are based on CDMA and OFDMA technologies respectively. In addition the control channels and their structure would also differ in the two systems. This indeed may lead to different measurement methods in the two systems. But regardless of the round trip time measurement mechanism and principles, its meaning is the same in E-UTRAN as in UTRAN in the sense that it enables the network 135 to find the complete round trip time.

The signal 520 is sent as a response to the first sent signal 510. When the base station 110 receives the signal 520 in response to the previously sent signal 510 the Round Trip Time may be calculated at the base station 110.

In order to being able to calculate the round trip time in step 530, or the distance between the base station 110 and the user equipment 120, attention may be paid to the fact that the downlink and uplink may not be aligned in the user equipment 120. For this reason the time between reception of the downlink frame 510 in the user equipment 120 and the transmission of the uplink frame 520 from the user equipment 120 may have to be subtracted from the round trip time measurement. After this, the distance between the base station 110 and the user equipment 120 may be estimated by performing a division by 2 and a multiplication by the speed of light.

When the round trip time has been computed in step 530, the result is reported 540 back to the user equipment 120.

The computed and reported round trip time 540 may be used e.g. for geographical positioning by generating a fingerprint based on the computed round trip time 540.

The geographical positioning may be performed by firstly letting the user equipment 120 generate a fingerprint based on the computed round trip time 540. The generated fingerprint may then be sent to the positioning node 140.

The positioning node 140 may perform a radio fingerprint lookup to obtain the user equipment's 120 geographic position, and then may send a message that comprises the determined geographic position data to the user equipment 120, or to other nodes external to the PLMN such as e.g., to GIS server 150, an emergency or police call centre, etc.

The radio fingerprint lookup may comprise matching the obtained radio fingerprint measurement with previously stored radio fingerprint measurements. The stored geographic position data, that corresponds to matching radio fingerprint measurements, may be retrieved as the user equipment's 120 geographic position.

An appropriate way of sending the round trip time 540 from the base station 110 to the user equipment 120 or, alternatively, from the user equipment 120 to the base station 110 may be via the radio resource control (RRC) protocol i.e. layer 3. Alternatively it may also be signalled via medium access control (MAC) i.e. layer 2.

Thus, according to some embodiments, the round trip time may be signalled to the user equipment 120 via the Radio Resource Control (RRC) protocol i.e. layer 3 Alternatively it may be signalled via Medium Access Control (MAC) i.e. layer 2. Further, it may be possible to transmit this measurement in an application which is mapped on the user plane.

According to some optional embodiments, the measured signal propagation time may alternatively be reported 550 to the positioning node 140.

Signalling Methods

The signalling methods are the means which allow reduction of signalling overheads but at the same time ensure that measurements are available when needed. They may therefore set optimum delivery of the round trip time to the user equipment 120 and/or to the network 135 for user equipment based and/or network/base station based positioning methods, respectively. The signalling according to the present method may be based on any of the three principles periodical reporting, event triggered reporting or event triggered periodical reporting. These three report method principles will in the following be further explained in detail.

Periodical Reporting

The propagation delay is reported at regular interval when using periodical reporting. Typically the base station 110 may measure the round trip time when the user equipment 120 transmits PRACH in relation to the received downlink signal e.g. downlink frame timing, synchronization signal timing, pilot signal timing etc, or other channels in the uplink, such as PUCCH in response to downlink transmission of PDCCH n E-UTRAN.

The determination of the reporting rate in periodical reporting may be based on various parameters such as e.g. the cell size, the change in position of the user equipment 120, or the speed of the user equipment 120. The reporting rate may also be a function of DRX cycle.

According to some embodiments, the network 135 may set some fixed periodic signalling rate, for instance depending upon the cell size. Thus in large cells, the signalling may be done more frequently assuming the user equipment 120 will move faster and vice versa.

However, according to some embodiments, the reporting rate may be set as a function of a change in position. According to these embodiments, the network 135 may adjust or modify the reporting rate depending upon the change in the position of the user equipment 120 over the last monitoring duration. For instance if the user equipment 120 has not changed position significantly over time, then the signalling rate, i.e. reporting the round trip time, may be reduced. The network 135 may also perform a double check by comparing the previously signalled and currently measured round trip time samples. If the position of the user equipment 120 has not changed significantly, then both measurement samples would be in the same range. However the opposite is not necessarily true. Although the position of the user equipment 120 might have changed over time, the round trip time might still be in the same range.

This approach may reduce signalling overheads while the user equipment 120 positioning may still be tracked with required accuracy.

The reporting rate may, according to some embodiments be a function of the speed of the user equipment 120. The network 135 may according to these embodiments adjust or modify the reporting rate depending upon the speed of the user equipment 120. It may be assumed that the signalling concerning the round trip time may be performed more frequently if the speed of the user equipment 120 is high, as this implicates a change in geographical position.

According to some embodiments, the reporting rate may be a function of the DRX cycle. When DRX is in use, the network 135 may at most signal the propagation delay to the user equipment 120, 130 once every DRX. Therefore, in DRX mode, which may be employed also in connected mode, the network 135 may with certain advantage adjust the periodical reporting rate as a function of DRX cycle.

Regardless of whether the DRX is in use or not, the base station 110 may perform round trip time whenever uplink transmission occurs. Note that uplink transmission may take place independent of the DRX cycle. Therefore the network 135 may send the round trip time to the positioning node 140 with any rate irrespective of the DRX cycle in operation.

Event Triggered Reporting

According to some embodiments, the round trip time may be sent in response to an event. The event may be e.g. after the measurement of the round trip time or when the position change of the user equipment 120 exceeds a certain threshold value.

The event may occur in the base station 110, which performs the round trip time measurement according to some embodiments. In UTRAN the RNC may configure such an event at the base station 110, i.e. Node B, for transmitting measurement, at the user equipment 120 and at the positioning node 140 for receiving measurement according to the said event. In E-UTRAN this may be an internal event at the eNode B 110, which in turn may also configure the user equipment 120 and the positioning node 140 for receiving the round trip time according to the occurred event.

According to some embodiments, the round trip time may be sent to the user equipment 120 and/or the positioning node 140 after the measurement of round trip time. According to those embodiments, the round trip time may be sent whenever the base station 110 performs round trip time measurement, especially while receiving PRACH or other unilateral control channel in the uplink.

According to some embodiments, the round trip time may be signalled to the user equipment 120 and/or the positioning node 140 when the change in position of the user equipment 120 exceeds a threshold value. The network 135 may according to these embodiments, send the round trip time if it is detected that the position of the user equipment 120 has changed beyond some threshold level. Similarly, if the position of the user equipment 120, 130 has not changed over a pre-determined time period, then the network 135 may not send any new value of the round trip time. The network 135 may also perform a double check by comparing the previously sent round trip time and currently measured round trip time samples. If the user equipment position has not changed significantly, then both measurement samples may be expected to be found in the same range. However the opposite is not necessarily true. Thus, although the user equipment 120 position might have changed over time, the round trip time may still be in the same range.

Event Triggered Periodical Reporting

According to some embodiments, the reporting of the round trip time may be performed periodically after the occurrence of some event. The triggering event may be e.g. when the change in round trip time exceeds a certain threshold value, when the change of position of the user equipment 120 exceeds a certain threshold value, when the user equipment 120 speed exceeds a certain threshold value etc.

According to some embodiments, the reporting of the propagation delay is performed when the change in round trip time exceeds a certain threshold limit value. According to this method if there is significant change in the round trip time over a pre-determined time the network 135 starts periodical reporting of the round trip time. The network 135 reverts to the event reporting if the change in the round trip time falls below another certain threshold limit value over a pre-determined time.

According to some embodiments, the network 135 may start periodical reporting of the measured propagation delay when the change of position of the user equipment 120 exceeds a certain threshold limit value. The threshold limit value may be predetermined and set e.g. by the network 135.

The network 135 may revert to the event reporting if the change in the user equipment position falls below another threshold, over a pre-determined time.

According to some embodiments, the network 135 may start periodical reporting of the round trip time if the user equipment 120 speed exceeds a certain threshold limit value over a pre-determined time. The network 135 may revert to the event reporting paradigm if the user equipment 120 speed falls below another threshold limit value over a pre-determined time.

The user equipment 120 speed may be determined in several ways. The speed of the user equipment 120 may e.g. be be tracked at the base station 110 by measuring the Doppler frequency of the user equipment 120 under consideration.

The round trip time may be reported in terms of number of chips in UTRAN and/or as a function of cyclic prefix in E-UTRAN, according to some embodiments. The normal and extended Control Plane (CP) lengths in E-UTRAN may be e.g. in the order of 5 and 16 μs respectively. Since round trip time can be very fine therefore in E-UTRAN the reporting can still be done in terms of number of CP (N). However rules can be defined to derive the actual round trip time (Dₚ). For instance:

Dₚ=2^{k×N}

Where N is an integer which can take any positive and negative value; k is a constant. Another possibility is to report it in the scale of nano or micro second.

According to some embodiments, the report of the absolute value of the round trip time may be followed by several different reports. The differential means the difference between the previous and current absolute round trip time e.g. AN in case of E-UTRAN. One bit may indicate whether the reported quantity is absolute or differential.

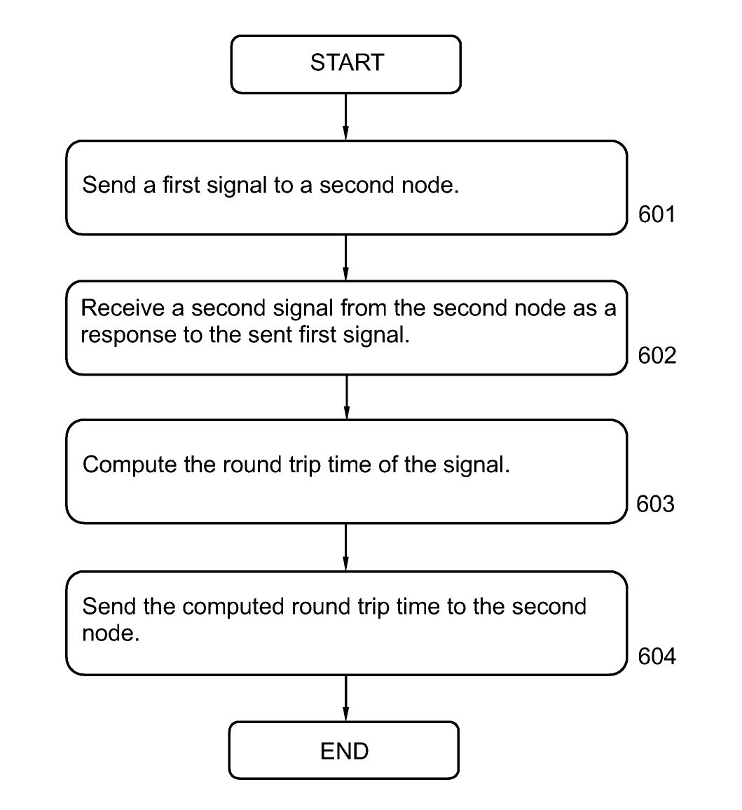

FIG. 6 is a flow chart illustrating a method in a first node 110, for determining the round trip time of a signal sent between the first node 110 and a second node 120. The second node 120 is associated with a location point. The first node 110 and the second node 120 are comprised within a wireless communication system 100. Further, the first node 110 and the second node 120 are adapted to exchange wireless signals.

The first node 110 may be represented by a base station and the second node 120 may be represented by a user equipment, such as e.g. a mobile terminal, according to some embodiments. However, according to some different embodiments, the first node 110 may be represented by a user equipment and the second node 120 may be represented by a base station.

To appropriately send the value of the round trip time, the method may comprise a number of steps 601-604. It is however to be noted that some parts of the described method steps are optional and only comprised within some embodiments. Further, it is to be noted that the method steps 601-604 may be performed in any arbitrary chronological order and that some of them, e.g. step 602 and step 603, or even all steps may be performed simultaneously or in an altered, arbitrarily rearranged, decomposed or even completely reversed chronological order. The method comprises the following steps:

Step 601

A first signal is sent to the second node 120.

According to some optional embodiments, the first signal may be sent to the second node 120 over one of the following channels in Evolved Universal Terrestrial Radio Access Network, E-UTRAN: Physical Uplink Control Channel, PUCCH, Physical Downlink Control Channel, PDCCH, Physical Random Access Channel, PRACH, downlink synchronization signal or downlink common reference signal.

However, according to some optional embodiments, the first signal may be sent to the second node 120 over one of the following channels in Wide-band Code Division Multiple Access, WCDMA: Downlink Dedicated Physical Control CHannel, DPCCH, Fractional Downlink Dedicated Control CHannel, F-DPCH, Physical Random Access CHannel, PRACH, downlink synchronization signal or downlink common pilot signal.

Step 602

A second signal, corresponding to the sent first signal, is received from the second node 120. The signal is sent from the second node 120, as a response to the sent first signal.

According to some optional embodiments, the second signal may be received from the second node 120 over one of the following channels in E-UTRAN: PUCCH, PDCCH, PRACH, downlink synchronization signal or downlink common reference signal.

According to some optional embodiments, the second signal may be received from the second node 120 over one of the following channels in WCDMA: DPCCH, F-DPCH, PRACH, downlink synchronization signal or downlink common pilot signal.

Step 603

The round trip time of the signal is computed.

The round trip time of the signal may be computed by measuring the time from the first signal is sent and the second signal is received at the first node, according to some embodiments. A subtraction may be made to compensate for the time it takes for the second node 120 to start sending the second signal when it has received the first signal from the first node 110. This time delay may be due to e.g. conversion from receiving mode to sending mode in the transceiver 405.

Step 604

The computed round trip time is sent to the second node 120.

According to some optional embodiments, the computed round trip time may be sent to the second node 120 using one of the protocols: radio resource control protocol or medium access protocol.

The sending of the computed round trip time may, according to some optional embodiments, be performed periodically.

The sending of the computed round trip time may, according to some optional embodiments, be performed at a periodicity which is determined based on a property out of the group: magnitude of a position change of the second node 120, speed of the second node 120 or the periodicity of a Discontinuous Reception cycle, DRX.

However, according to some optional embodiments, the computed round trip time may be sent in an event triggered fashion.

The triggering event may according to some embodiments be the measurement of the round trip time, or when a position change of the second node 120, exceeds a certain threshold value.

However, according to some embodiments, the sending of the computed round trip time may be performed in event triggered periodical fashion. Thus the computed round trip time may be sent periodically, if a threshold limit value is exceeded and sent in event triggered fashion if the threshold limit value is not exceeded.

According to some embodiments, the threshold limit value may concern a second node parameter out of the group: difference between two measurements of round trip time, magnitude of a position change of the second node 120 or speed of the second node 120.

To perform the method steps 601-604 above, the first node 110 comprises an arrangement 700, depicted in FIG. 7. The arrangement 700 is configured for determining the round trip time of a signal sent between the first node 110 and a second node 120. The second node 120 is associated with a location point. The first node 110 and the second node 120 are comprised within a wireless communication system 100. Also, the first node 110 and the second node 120 are adapted to exchange wireless signals.

The arrangement 700 comprises a first sending unit 701. The first sending unit 701 is adapted to send a first signal to the second node 120. Further, the arrangement 700 comprises a receiving unit 702. The receiving unit 702 is adapted to receive a second signal, corresponding to the sent first signal. The second signal has been sent from the second node 120, as a response to the first signal. Further yet, the arrangement 700 comprises a computing unit 703. The computing unit 703 is adapted to compute the round trip time of the signal. Still further, the arrangement 700 also comprises a second sending unit 704. The second sending unit 704 is adapted to send the computed round trip time to the second node 120.

It is to be noted that any internal electronics of the first node 110 not completely necessary for performing the present method according to the method steps 601-604 such as e.g. some of the internal electronics of the base station 110 depicted in FIG. 3, has been omitted from FIG. 7, for clarity reasons.

The computing unit 703, which is comprised within the arrangement 700 in the first node 110 may be a processing unit.

The second sending unit 704 may according to some embodiments be configured to send the value of the computed round trip time using any of the protocols radio resource control protocol or medium access protocol.

The second sending unit 704 may according to some embodiments be configured to send the value of the computed round trip time periodically. The periodicity may be determined based on a property out of the group: magnitude of a position change of the second node 120, speed of the second node 120 or the periodicity of a Discontinuous Reception cycle, DRX.

However, according to some embodiments, the second sending unit 704 may be configured to send the value of the computed round trip time in event triggered fashion. The triggering event may be e.g. a measurement of signal propagation delay, or when a position change of the second node 120 exceeding a certain threshold value, is detected.

According to some embodiments the second sending unit 704 may be configured to send the value of the computed round trip time in an event triggered periodical fashion.

Further, according to some embodiments, the second sending unit 704 may be configured to send the value of the computed round trip time periodically; if a threshold limit value is exceeded. Otherwise, if the threshold limit value is not exceeded, the second sending unit 704 may be configured to send the value of the computed round trip time in an event triggered fashion.

According to some embodiments, the threshold limit value concerns a second node parameter out of the group: signal propagation delay, magnitude of a position change of the second node 120 or speed of the second node 120.

It is to be noted that the described units 701-704 comprised within the arrangement 700 in the first node 110 are to be regarded as separate logical entities but not with necessity separate physical entities. Any, some or all of the units 701-703 may be comprised or co-arranged within the same physical unit. However, in order to facilitate the understanding of the functionality of the arrangement 700 in the first node 110, the comprised units 701-704 are illustrated as separate physical units in FIG. 7.

As an example of the latter, the first sending unit 701, the second sending unit 704 and the receiving unit 702 may, according to some embodiments, be comprised within one physical unit, a transceiver, which may comprise a transmitter circuit and a receiver circuit, which respectively transmits outgoing radio frequency signals to the second node 120 and receives incoming radio frequency signals from the second node 120 via an antenna. The antenna may be an embedded antenna, a retractable antenna or any antenna known to those having skill in the art without departing from the scope of the present invention. The radio frequency signals transmitted between the second node 120 and the first node 110 may comprise both traffic and control signals e.g., paging signals/messages for incoming calls, which may be used to establish and maintain a voice call communication with another party or to transmit and/or receive data, such as SMS, e-mail or MMS messages, with a remote user equipment 130.

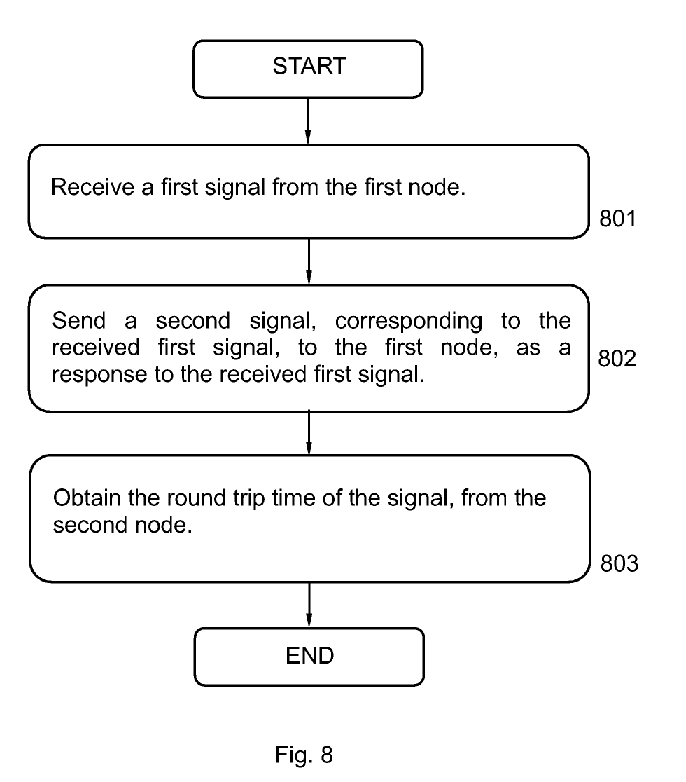

FIG. 8 is a flow chart illustrating a method in a user equipment 120, for obtaining the round trip time of a signal sent between a first node 110 and the second node 120. The second node 120 is associated with a location point. The first node 110 and the second node 120 are comprised within a wireless communication system 100. Further, the first node 110 and the second node 120 are adapted to exchange wireless signals. The wireless communication system 100 may be e.g. UTRAN or EUTRAN. The first node 110 may be represented by a base station, such as e.g. a Node B or an e-Node B. The second node 120 may be represented by a user equipment such as e.g. a mobile telephone. However, according to some embodiments, first node 110 may be represented by a user equipment such as e.g. a mobile telephone and the second node 120 may be represented by a base station, such as e.g. a Node B or an e-Node B.

To appropriately obtain the round trip time of the signal, the method may comprise a number of steps 801-803. It is however to be noted that some parts of the described method steps are optional and only comprised within some embodiments. The method comprises the following steps:

Step 801

A first signal is received from the first node 110.

According to some optional embodiments, the first signal may be received from the first node 110 over one of the following channels in E-UTRAN: Physical Uplink Control Channel, PUCCH, Physical Downlink Control Channel, PDCCH, Physical Random Access Channel, PRACH, downlink synchronization signal or downlink common reference signal.

However, according to some optional embodiments, the first signal may be received from the first node 110 over one of the following channels in WCDMA: Downlink Dedicated Physical Control CHannel, DPCCH, Fractional Downlink Dedicated Control CHannel, F-DPCH, Physical Random Access CHannel, PRACH, downlink synchronization signal or downlink common pilot signal.

Step 802

A second signal, corresponding to the received first signal is sent to the first node 110, as a response to the received first signal.

According to some optional embodiments, the second signal may be sent to the first node 110 over one of the following channels in E-UTRAN: PUCCH, PDCCH, PRACH, downlink synchronization signal or downlink common reference signal.

According to some optional embodiments, the second signal may be sent to the first node 110 over one of the following channels in WCDMA: DPCCH, F-DPCH, PRACH, downlink synchronization signal or downlink common pilot signal.

Step 803

The round trip time of the signal is received from the second node 120.

FIG. 9 schematically depicts an embodiment of an arrangement 900 in a second node 120. The arrangement 900 is configured to obtain the round trip time of a signal sent between a first node 110 and the second node 120. The second node 120 is associated with a location point. The first node 110 and the second node 120 are comprised within a wireless communication system 100. The first node 110 and the second node 120 are further adapted to exchange wireless signals.

The arrangement 900 comprises a receiving unit 901. The receiving unit 901 is adapted to receive a signal from the first node 110. Further, the arrangement 900 comprises a sending unit 902. The sending unit 902 is adapted to send a second signal, corresponding to the received first signal, to the first node 110, as a response to the received first signal. Also, the arrangement 900 comprises an obtaining unit 903. The obtaining unit 903 is adapted to obtain the round trip time of the signal from the second node 120.

It is to be noted that any internal electronics of the second node 120 not completely necessary for performing the present method according to the method steps 801-803, such as e.g. some of the internal electronics of the second node 120 depicted in FIG. 4, has been omitted from FIG. 9, for clarity reasons.

It is to be noted that some of the described units in the arrangement 900 in the second node 120, such as e.g. 901 and 902, are to be regarded as separate logical entities but not with necessity separate physical entities. The receiving unit 901 and the sending unit 902 may be comprised or co-arranged within the same physical unit. As an example of the latter, the receiving unit 901 and the sending unit 902 may according to some embodiments be comprised within one physical unit, a transceiver, which may comprise a transmitter circuit and a receiver circuit, which respectively transmits outgoing radio frequency signals to the first node 110 and receives incoming radio frequency signals from the first node 110 via an antenna. The antenna may be an embedded antenna, a retractable antenna or any antenna known to those having skill in the art without departing from the scope of the present invention. The radio frequency signals transmitted between the second node 120 and the first node 110 may comprise both traffic and control signals e.g., paging signals/messages for incoming calls, which may be used to establish and maintain a voice call communication with another party or to transmit and/or receive data, such as SMS, e-mail or MMS messages, with a remote user equipment 130.

Some Particular Embodiments

The present methods for sending and obtaining, respectively, a round trip time of a signal sent between the first node 110 and the second node 120 may be implemented through one or more processors in the first node 110 and/or the second node 120 together with computer program code for performing the functions of the present methods. The program code mentioned above may also be provided as a computer program product, for instance in the form of a data carrier carrying computer program code for performing the methods according to the respective method steps when being loaded into the processor unit. The data carrier may be e.g. a CD ROM disc, a memory stick, or any other appropriate medium such as a disk or tape that can hold machine readable data. The computer program code may furthermore be provided as pure program code on a server and downloaded to the first node 110 and/or the second node 120 e.g. remotely.

Thus a computer readable medium encoded with a computer program for providing a round trip time of a signal sent between the first node 110 and the second node 120 may perform the method according to the method steps 601-604.

Thus also a computer readable medium encoded with a computer program for obtaining a round trip time of a signal sent between the first node 110 and the second node 120 may perform the method according to the method steps 801-803.

1. A method in a first node, for determining the round trip time of a signal sent between the first node and a second node, the second node is associated with a location point, the first node and the second node are comprised within a wireless communication system and adapted to exchange wireless signals, the method of comprising:
sending a first signal to the second node,
receiving a second signal, corresponding to the sent first signal, where the second signal has been sent from the second node, as a response to the sent first signal,
computing the round trip time of the signal, and
sending the computed round trip time to the second node.

2. The method of claim 1, wherein the step of sending the first signal to the second node is performed over one of the following channels in an Evolved Universal Terrestrial Radio Access Network (E-UTRAN): Physical Uplink Control CCH), Physical Downlink Control Channel (PDDCH), Physical Random Access Channel (PRACH), downlink synchronization signal or downlink common reference signal.

3. The method of claim 1, wherein the step of receiving the second signal from the second node is performed over one of the following channels in E-UTRAN: PUCCH, PDCCH, PRACH, downlink synchronization signal or downlink common reference signal.

4. The method of claim 1, wherein the step of sending the first signal to the second node is performed over one of the following channels in Wide-band Code Division Multiple Access (WCDMA): Downlink Dedicated Physical Control Channel (DPCCH), Fractional Downlink Dedicated Control Channel (F-DPCH), Physical Random Access Channel (PRACH), downlink synchronization signal or downlink common pilot signal.

5. The method of claim 1, wherein the step of receiving the second signal from the second node is performed over one of the channels in WCDMA: DPCCH, F-DPCH, PRACH, downlink synchronization signal or downlink common pilot signal.

6. The method of claim 1, wherein the step of sending the computed round trip time to the second node is performed using one of the protocols: radio resource control protocol or medium access protocol.

7. The method of claim 1, wherein the step of sending the computed round trip time is performed periodically.

8. The method of claim 7, wherein the step of sending the computed round trip time is performed at a periodicity which is determined based on a property out of the group: magnitude of a position change of the second node, speed of the second node or the periodicity of a Discontinuous Reception cycle (DRX).

9. The method of claim 1, wherein the step of sending the computed round trip time is performed in event triggered fashion.

10. The method of claim 9, wherein the triggering event is a measurement of round trip time, or when a position change of the second node, exceeds a certain threshold value.

11. The method of claim 1, wherein the step of sending the computed round trip time is performed in event triggered periodical fashion.

12. The method of claim 11, wherein the step of sending the computed round trip time is performed periodically, if a threshold limit value is exceeded and wherein the step of sending the computed round trip time is performed in event triggered fashion if the threshold limit value is not exceeded.

13. The method of claim 12, wherein the threshold limit value concerns a second node parameter out of the group: difference between two measurements of round trip time, magnitude of a position change of the second node or speed of the second node.

14. The method of claim 1, wherein the first node comprises a base station and the second node comprises a user equipment.

15. The method of claim 1, wherein the first node comprises a user equipment and the second node comprises a base station.

16. An apparatus in a first node for determining a round trip time of a signal sent between the first node and a second node, wherein the second node is associated with a location point, the first node and the second node are comprised within a wireless communication system and are adapted to exchange wireless signals, the apparatus comprising:
a first sending unit, adapted to send a first signal to the second node,
a receiving unit, adapted to receive a second signal, corresponding to the sent first signal, which second signal has been sent from the second node, as a response to the first signal,
a computing unit, adapted to compute the round trip time of the signal, and
a second sending unit, adapted to send the computed round trip time to the second node.

17. A method in a second node, for obtaining a round trip time of a signal sent between a first node and the second node, the second node is associated with a location point, the first node and the second node are comprised within a wireless communication system and adapted to exchange wireless signals, the method comprising:
receiving a first signal from the first node,
sending a second signal, corresponding to the received first signal, to the first node, as a response to the received first signal,
obtaining the round trip time of the signal, from the first node.

18. The method of claim 17, wherein the first node is represented by a base station and the second node is represented by a user equipment.

19. The method of claim 17, wherein the first node is represented by a user equipment and the second node is represented by a base station.

20. An apparatus in a second node, for obtaining the round trip time of a signal sent between a first node and the second node, the second node is associated with a location point, the first node and the second node are comprised within a wireless communication system and adapted to exchange wireless signals, the apparatus comprising:
a receiving unit, adapted to receive a first signal from the first node,
a sending unit, adapted to send a second signal, corresponding to the received first signal, to the first node, as a response to the received first signal,
an obtaining unit, adapted to obtain the round trip time of the signal from the first node.
